(19) United States
(12) Patent Application Publication
(10) Pub. No.: US 2026/0366494 A1
(43) Pub. Date: Nov. 19, 2026

(54) Bi-Level Interturn Short-Circuit Fault Monitoring for Wind Turbine Generators

(71) Applicant: Board of Regents, The University of Texas System, Austin, TX (US)

(72) Inventors: Jie Zhang, Allen, TX (US); Jingyi Yan, Richardson, TX (US); Soroush Senemmar, Dallas, TX (US)

(21) Appl. No.: 19/211,668

(22) Filed: May 19, 2025

Related U.S. Application Data
(60) Provisional application No. 63/649,390, filed on May 19, 2024.

(51) Int. Cl. F03D 17/00

(52) U.S. Cl. CPC F03D 17/014; F03D 17/0065; F03D 17/021; F03D 17/036; F05B 2260/80; F05B 2270/703; F05B 2270/709; F05B 2270/803

(57) ABSTRACT

Monitoring and maintaining wind turbine performance is provided. The method comprises sampling electrical signals from a wind turbine system and applying discrete wavelet transformation to extract time and frequency information from the electrical signals. At each timestep, a first machine learning model estimates, according to the time and frequency information extracted from the electrical signals, a fault severity of electrical components within the wind turbine system, wherein the fault severity is characterized as mild, medium, or severe according to predefined parameters. Responsive to the fault severity characterized as medium or severe, a second machine learning model identifies a faulty phase in the wind turbine system based on the electrical signals. Fault location information is then provided to service personnel for medium and severe fault severity.

### CROSS-REFERENCE TO RELATED APPLICATION

This application claims priority to U.S. Provisional Application 63/649,390, filed May 19, 2024, the entirety of which is hereby incorporated by reference in its entirely.

### STATEMENT OF GOVERNMENT SUPPORT

This invention was made with government support under contract 1916776 awarded by the National Science Foundation. The Government has certain rights in this invention.

### BACKGROUND INFORMATION

### 1. Field

The present invention relates in general to wind turbines, and more specifically to fault monitoring in wind turbine generators.

### 2. Background

According to the U.S. Department of Energy's 2023 wind market report, wind power constituted 22% of new electricity capacity installed in the United States in 2022, totaling 77 GW globally. However, the harsh working environment and remote locations result in high failure rates and maintenance costs for wind turbines. Preventive maintenance, which involves regular inspections and maintenance before failures occur, can help reduce the failure rate. Nevertheless, the associated costs of prevention, including transportation, labor, and downtime, remain high. In contrast, an online condition monitoring and fault diagnosis (CMFD) system uses sensors and data acquisition systems to monitor the condition of WTs in real time without interrupting production. This approach minimizes maintenance costs and downtime while improving the reliability and productivity of the wind farm.

A wind turbine is an electromechanical system that captures kinetic energy from the wind and converts it into carbon-free electricity. This conversion process is carried out by the wind turbine's rotors and generator. Typically, a gearbox is included to increase the rotor speed before it reaches the generator. A converter and transformer then step up the voltage from the generator before integrating it into the grid. A number of studies have been performed in the literature on wind turbine condition monitoring. For example, Dao et al. analyzed the critical components in wind turbine systems, identifying generators and gearboxes as the two most critical subassemblies in terms of downtime and repair times. These components account for 24.2% of downtime in onshore wind turbines and 33.3% in offshore wind turbines.

The wind turbine market favors doubly fed induction generators (DFIGs) due to their efficiency, reliability, controllability, and cost effectiveness. Around 30-40% of faults in electrical machines are stator winding interturn short-circuit faults (ITSCFs). These faults, caused by electrical or mechanical stress leading to overheating, are among the most severe and rapidly developing issues. Undetected turn-to-turn faults can escalate to phase-to-phase and phase-to-ground failures, ultimately causing motor outages.

While traditional fault diagnosis relies heavily on the expertise of engineers and technicians, the rapid development of machine learning (ML)-based CMFD systems offers a promising alternative. These systems can reduce human labor, shorten maintenance cycles, and improve diagnosis accuracy. In the context of wind turbine systems, ML techniques are used for condition classification (determining if the system is healthy or faulty and assessing fault severity) and behavior prediction (identifying abnormalities). For example, Attallah et al. incorporated eight different convolutional neural network (CNN) structures to extract features from infrared images. Their experiments included one healthy state, two noninterturn faults (blocked rotor fault and cooling fan failure), and eight interturn faults (varying by faulty winding ratios and numbers of faulty phases) on an induction generator. The selective features allowed the classifiers to successfully identify all fault classes. However, the reliance on infrared cameras, which can be expensive and labor-intensive, is a drawback, as is the framework's inability to locate faulty phases in ITSCF scenarios.

All large utility-scale wind turbine systems are equipped with Supervisory Control and Data Acquisition (SCADA) systems, primarily used for monitoring and control. Extensive CMFD systems are built on 10-min sampled data from SCADA systems, avoiding the need for additional sensors. However, since SCADA systems were not originally designed for CMFD purposes, the low sampling frequency may not provide sufficient information for condition monitoring, especially for electrical subsystems where characteristics are evident in both time and frequency domains.

In ITSCF research, only a few datasets are available as opensource. Notably, three out of the four known datasets feature high sampling frequencies, emphasizing the importance of high-frequency signals for ITSCF diagnosis. While most datasets account for differences in operating load, they typically maintain fixed settings for each run. However, the variable nature of wind speed distinguishes the operating situation of the generator from a steady-state operation. Both increased wind energy and initial short-circuit abnormalities can lead to elevated current signals. A reliable CMFD system must promptly detect abnormalities under variable operating conditions, underscoring the need for a benchmark dataset specifically within the context of wind turbine systems.

### SUMMARY

An illustrative embodiment provides a computer-implemented method of monitoring and maintaining wind turbine performance. The method comprises sampling electrical signals from a wind turbine system and applying discrete wavelet transformation to extract time and frequency information from the electrical signals. At each timestep, a first machine learning model estimates, according to the time and frequency information extracted from the electrical signals, a fault severity of electrical components within the wind turbine system, wherein the fault severity is characterized as mild, medium, or severe according to predefined parameters. Responsive to the fault severity characterized as medium or severe, a second machine learning model identifies a faulty phase in the wind turbine system based on the electrical signals. Fault location information is then provided to service personnel for medium and severe fault severity. Responsive to a severe fault, the generator in the wind turbine system may be tripped. According to other illustrative embodiments, a computer system and a computer program product for monitoring and maintaining wind turbine performance are provided.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a wind turbine system to which the illustrative embodiments may be applied;

FIG. 2 depicts a table of existing open-source datasets for ITSCF diagnosis and the proposed open-source dataset of the illustrative embodiments;

FIG. 3 illustrates an ITSCF condition in phase A of the wind turbine generator stator;

FIG. 4 depicts a table of severity categories of ITSCFs;

FIG. 5 illustrates a bi-level condition monitoring framework in accordance with an illustrative embodiment;

FIG. 6 depicts a diagram of an LSTM unit in the hidden layer of an RNN in accordance with an illustrative embodiment;

FIG. 7 depicts a GRU unit in the hidden layer of an RNN in accordance with an illustrative embodiment; and

FIG. 8 depicts a flowchart illustrating a process for monitoring and maintaining wind turbine performance in accordance with an illustrative embodiment.

### DETAILED DESCRIPTION

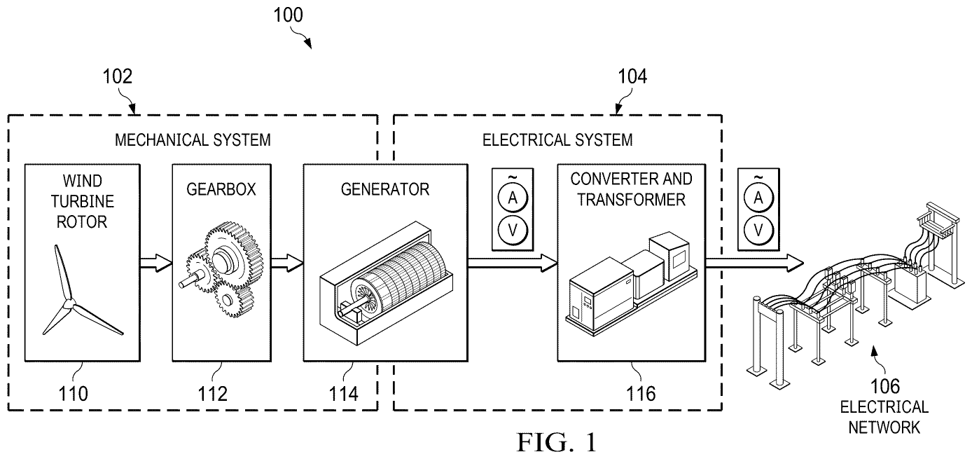

Referring to the figures, FIG. 1 depicts a wind turbine system to which the illustrative embodiments may be applied. Wind turbine system 100 comprises mechanical system 102 and electrical system 104. Wind turbine system 100 is connected to electrical network 106.

Mechanical system 102 comprises wind turbine rotor 110, gearbox 112, and generator 114. Electrical system also comprises generator 114 plus converter and transformer 116. The method of the illustrative embodiments may be applied to data collected from the generator 114 or from the transformer 116.

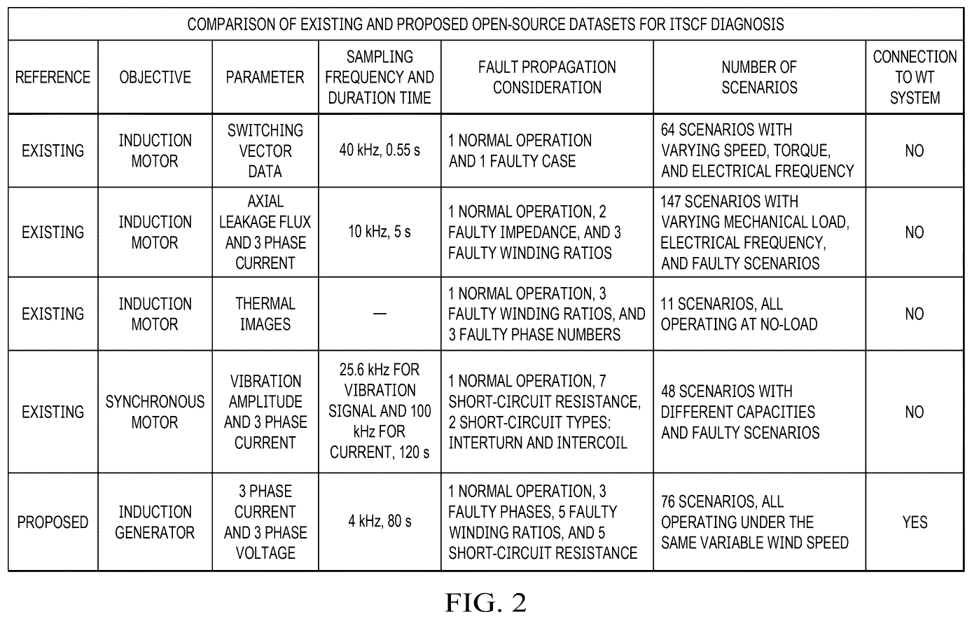

To address the challenge of accessing high-frequency benchmark datasets for condition monitoring of electrical components in energy systems and to advance the data-driven CMFD community, we have created an open-source benchmark dataset comprising 75 ITSCF scenarios. These scenarios include variations in faulty phases, faulty winding ratios, and short-circuit resistances. For future dataset enrichment, we leverage a widely used and open-source wind turbine model from The MathWorks, Inc., enabling the simulation and sharing of additional scenarios. FIG. 2 depicts a table of existing open-source datasets for ITSCF diagnosis and the proposed open-source dataset of the illustrative embodiments.

Using this benchmark dataset, we have developed a bi-level ML-based condition monitoring framework for ITSCF identification and severity estimation. The framework of the illustrative embodiments includes modules for data processing, ITSCF severity estimation, and faulty phase identification, incorporating state-of-the-art methodologies for future tasks.

The illustrative embodiments provide (1) an accurate, cost-effective, and reliable condition monitoring framework to continuously monitor the health of the wind turbine generator stator, ultimately enhancing the efficiency, productivity, and reliability of wind turbines, and (2) an open-source dataset comprising 75 ITSCF scenarios in the wind turbine generator stator, capturing faulty features under varying wind speed conditions, which serves as a benchmark for future CMFD algorithms in the community.

Elements of the illustrative embodiments include:
(1) An adjustable framework that effectively detects ITSCFs, identifies faulty phases, and estimates severity. This framework can handle biased dataset structures in the context of condition monitoring.
(2) An open-sourced and expandable benchmark dataset of ITSCFs for wind turbine generator stators, fostering research and development comparability in wind turbine CMFD.
(3) Comparative analysis using numerous simulated ITSCF scenarios in the training set.

The illustrative embodiments recognize and take into account that the primary cause of ITSCFs is the degradation of the turn-to-turn insulation layer. In this study, we consider ITSCF not as a sudden short-circuit failure but as a developmental process. This process is influenced by both the faulty winding percentage and the short-circuit resistance, which results from the gradual degradation of the winding insulation.

In addition to a 1.5-MW wind turbine system, the MATLAB/SIMULINK wind turbine example simulates environmental wind speed and grid interactions. The simulation includes detailed modeling of the rotors, gear train, generator, and control systems. Specifically, the stator winding of the lumped star-connected DFIG is modeled based on the generator's equivalent impedance, R=0.0027Ω. We first partition the equivalent impedance into healthy and faulty parts. A small resistor bypassing the faulty winding simulates the interturn short circuit. To collect the electrical signals, three-phase current and voltage sensors are installed immediately after the generator to monitor the current and voltage output.

A faulty winding ratio, pₛ, is defined as the ratio of the faulty or degrading length to the total length of the winding, originating from a manufacturing defect. A series of increasing faulty winding ratios, pₛ∈0.05,0.1,0.2,0.3,0.5, represents the progression of degradation. Meanwhile, a series of decreasing short-circuit resistances, Rₛ∈1,0.1,0.01,0.001,0.0001Ω, bypassing the faulty winding, mimics the degradation process of the insulation material.

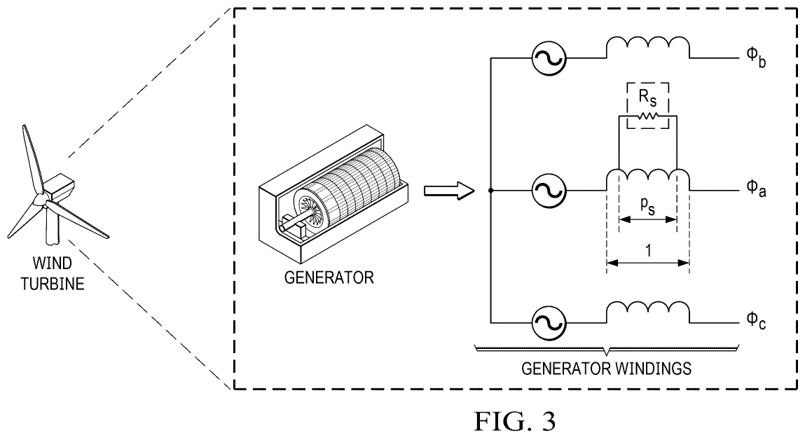

FIG. 3 illustrates an ITSCF condition in phase A of the wind turbine generator stator. Considering the total winding length as one unit, the shorted winding length is pₛ units. Conventionally, the symmetric nature of the star-connected stator results in identical analysis for an ITSCF, regardless of which phase is affected. However, modern automation demands and the need to minimize expert intervention require the CMFD system to identify the faulty phase while detecting the fault. Therefore, this study analyzes different faulty phases in addition to the five faulty winding ratios and five short-circuit resistances. Including the healthy scenario, the total number of simulated scenarios is 5×5×3+1=76.

For illustrative purposes, we executed the model and initiated the severest phase A ITSCF scenario (pₛ=0.5, Rₛ=0.0001Ω) from 35 to 40 s. While the generator voltage remains relatively stable, the ITSCF causes an increase in phase A current, leading to corresponding increases in phase B and C currents. As a consequence of induced currents and heightened heat generation, rotor speed declines.

In the generated dataset, each scenario spans 80 s of simulation time. Phase-to-phase current (in Amperes, A) and voltage (in volts, V) signals are recorded at a frequency of 4 kHz. A total of six signals are stored in a time-series format in a .mat file for each scenario, and all 76.mat files are zipped and made publicly available on Zenodo as a benchmark dataset for future research. To streamline data access, all scenario data is consolidated into single .mat and .csv files, accompanied by a metadata file. In addition to the dataset, the simulation model is uploaded to facilitate scenario enrichment by peer researchers.

The proposed benchmark dataset, along with the simulation model, benefits the design community by enhancing the comparability of research findings. Potential applications of the benchmark dataset and simulation model include:
Training and testing developed CMFD algorithms using the benchmark dataset, with or without noisy signals.
Developing a digital twin of the wind turbine generator that accounts for ITSCF propagation.
Expanding the dataset by generating additional electrical and mechanical faults using the wind turbine model, such as electrical faults in transformers or converters, and mechanical faults in gearboxes or rotors, and making these datasets open-source for the community.

In the present examples, three levels of white Gaussian noise signals are applied to the original signals for noisy resilience analysis. Condition monitoring methods are trained and tested with noisy signals for future reference.

The benchmark dataset adheres to the findable, accessible, interoperable, and reusable principles for the following reasons:
(1) Each signal in every scenario is made findable with associated metadata. The nomenclature of the 76 separate .mat files is defined within the metadata zip file, while headers for both the consolidated .mat and .csv files are specified in another metadata file.
(2) The dataset and simulation model can be accessed free of charge via the Zenodo repository.
(3) The dataset is interoperable with widely used .csv files for data-driven studies. Additionally, more storage-efficient .mat files are provided as alternative options.
(4) Comprehensive descriptions of the dataset, model, and metadata are available on the MATLAB/SIMULINK wind turbine example webpage, and in the Zenodo record, ensuring reusability. Further materials are accessible via the GitHub repository.

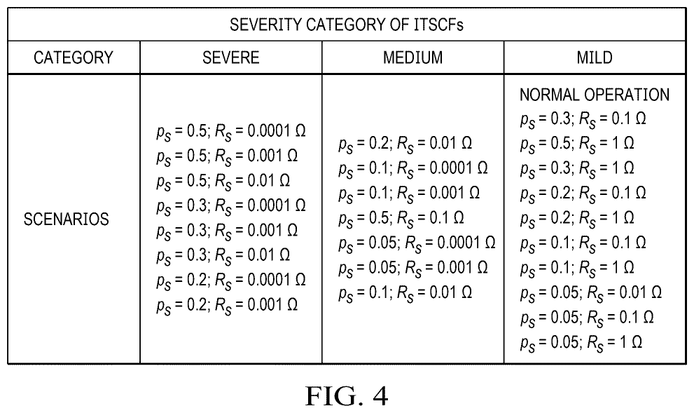

To provide insights for wind turbine operators, the 76 scenarios are categorized into three severity levels based on current signal analysis, rather than individually classifying each scenario. Under identical operating conditions, a higher faulty winding ratio and a smaller short-circuit resistance result in a broader current envelope. Three severity categories are manually defined based on the deviation between ITSCF and normal operation curves. Specific severity categories of ITSCFs for all scenarios can be found in the table in FIG. 4.

In this case study, the dataset includes more scenarios with faults than healthy conditions. While real-world datasets often have extensive samples of healthy conditions, their operational environments frequently overlap. To address the imbalanced structure between healthy and faulty datasets, instead of treating healthy conditions as a single class, we categorize them as representing mild severity. Recognizing the subjective nature of distinguishing between perfectly healthy and moderately abnormal conditions, which can vary among technicians, we propose three severity categories with corresponding action suggestions for wind turbine operators:
(1) Mild severity: Indicates the wind turbine generator is healthy or experiencing trivial abnormalities.
(2) Medium severity: Suggests the wind turbine generator requires repair.
(3) Severe severity: Urges immediate tripping of the wind turbine generator to prevent outage situations.

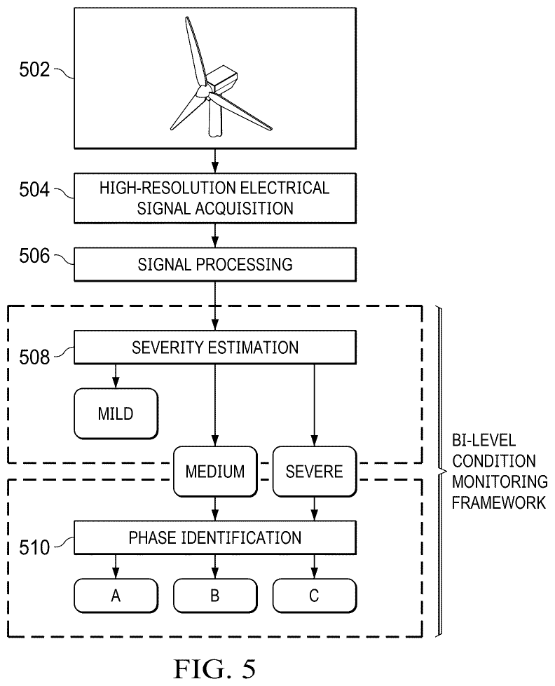

FIG. 5 illustrates a bi-level condition monitoring framework in accordance with an illustrative embodiment. High-resolution electrical signal acquisition 504 captures data regarding the operation of wind turbine 502.

The electrical signals are fed through a signal processing module 506 that extracts time and frequency information from high-resolution electrical signals. A severity estimation module 508 then determines if repair is necessary and decides whether to trip the generator to prevent failures. A faulty phase identification module 510 assists technicians in locating the fault. Only signals flagged as medium or severe severity are input into faulty phase identification module 510.

Considerable effort has been devoted to designing signal processing and ML classifiers tailored for condition monitoring. The illustrative embodiments leverage the discrete wavelet transform due to its excellent time-frequency localization capabilities and competitive performance demonstrated in wind turbine condition monitoring systems.

When selecting ML algorithms for severity estimation and phase identification, our criteria prioritize high accuracy, computational efficiency, and reliability. Recurrent neural networks (RNNs) and 2-dimensional convolutional neural networks (2D CNNs) are widely recognized for their ability to capture temporal and spatial dependencies in time-series data. In this study, we compare two RNN structures—long short-term memory (LSTM) and gated recurrent unit (GRU)—to a 2D CNN structure to integrate into our framework.

For any signal function ƒ(n) at timestamp n in the Hilbert space L²( [symbol] ), the wavelet series expansions involving a wavelet ψ∈L²( [symbol] ) and a scaling function φ∈L²( [symbol] ) can be expressed mathematically as shown in Eq. (1).

$$f ( n ) = {\sum }_{k ε ℤ} {a}_{{j}_{0} , k} {ϕ}_{{j}_{0} , k} ( n ) + {\sum }_{{j ϵℤ}_{j \geq {j}_{0}}} {\sum }_{k} {d}_{j , k} {ψ}_{j , k} ( n ) \qquad Eq . 1$$

where aⱼ_{₀}_{,k} and d_{j,k} represent approximation and detail coefficients, respectively, and j₀ denotes the level of decomposition. Both wavelet and scaling functions are predefined orthonormal basis functions. The detailed and approximation coefficients associated with them are computed using the inner product of the signal function ƒ(n) and carefully selected basic functions.

While RNNs are designed to learn information from historical data, their conventional gradient-based structure suffers from the vanishing and exploding gradient problem. LSTM and GRU are two refined structures that maintain long-term memories in the hidden layers, addressing these issues.

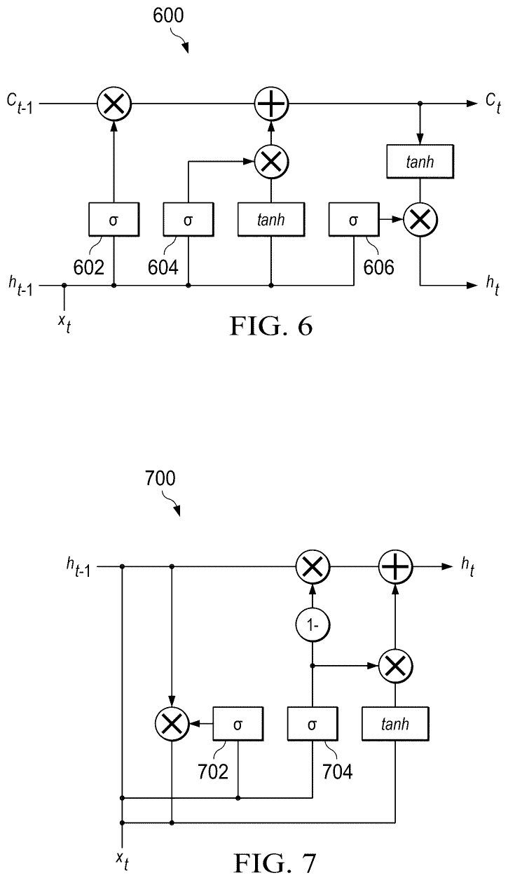

FIG. 6 depicts a diagram of an LSTM unit in the hidden layer of an RNN. In comparison, FIG. 7 depicts a GRU unit in the hidden layer of an RNN. Information flows from previous units to the latest one. In addition to the hidden state, hₜ, LSTM unit 600 also process a cell state, Cₜ, among the units. Each activation function, σ, acts as a gate in the unit. LSTM unit 600 has three gates: forget gate 602, input gate 604, and output gate 606. In contrast, GRU unit 700 contains only two gates: reset gate 702 and update gate 704. Consequently, GRU models tend to be faster and less complex than LSTM models.

Typically, in a CNN, information flows through a feed-forward network without backpropagation. In addition to conventional fully connected layers and normalization layers, a CNN structure includes convolutional layers, which process information from neighboring pixels, and pooling layers, which reduce the dimensionality of the data. These layers enable CNNs to extract useful features from large images. In the context of our signal processing, this 2D image consists of previous signal values, forming an input dataset with dimensions length (timestamps)×length (parameters).

All experimental scenarios contain 80 s signal records, with the generating mode of the wind turbine typically occurring between 18 and 47 s, varying slightly in each scenario. Therefore, we focus our analysis on the period between 20 and 45 s. Initially, all current data are input into the signal processing module 506, which outputs the first-level approximation coefficients for each phase using the Discrete Meyer wavelet. These raw current data and approximation coefficients for the three phases are then passed into the severity estimation module 508.

We compare four ML algorithms for both severity estimation and phase identification modules. To achieve this, the current data and coefficients are segmented into 50 time step intervals for each timestamp's input. Only data from 20 to 40 s are used to train and pretest the models, with a 70:10:20 train-validate-test split. The validate set here is used to tune the hyperparameters of the ML models. To guarantee that there is no overlap among three subsets, we partition the dataset before shuffling them for either training, validating, or testing the models. Although three subsets originate from the same faulty or healthy scenarios, they are taken from entirely different periods within a run. Notably, the variation of the rotor speed input into the generator's drive chain differs among the three sets. To prevent overfitting, the last 20% of the training data are reserved for validating and tuning the model's performance after each epoch.

In the present discussion, we also analyze the number of scenarios that are sufficient to train a diagnosis system for future experiment procedure reference. Therefore, the training, validating, and testing processes above are repeated four times with different numbers of faulty and healthy scenarios. Then, data from 40 to 45 s are used as a separate testing set. Unlike the 20-40 dataset, which might contain limited scenarios, the actual testing set contains all 76 scenarios. In this study, the training and pretesting processes are considered offline training and testing, while the actual test is regarded as an online implementation.

We also applied the proposed algorithms to noisy data. Enhancing accuracy in highly noisy environments remains a key objective for future work and for the broader research community.

All ML models were built using TensorFlow version 2.15.0. Simulations and signal processing were conducted using MATLAB version 2022a. For both the LSTM and GRU RNN architectures, four hidden layers were configured with 24, 48, 48, and 24 units, respectively, utilizing sigmoid activation functions. The 2D CNN structure included two convolutional layers with 24 and 48 2×2 filters, followed by two fully connected layers with 48 units each, all using ReLu activation functions. To prevent overfitting, a dropout rate of 10% was applied to the units in the hidden layers during training.

The architectures for both severity estimation and phase identification modules were identical. All models were trained using the Adam optimizer over 15 epochs, with categorical cross-entropy as the loss function and F-measure as the evaluation metric. Batch sizes varied depending on the number of scenarios in the training set, as detailed below.

In this study, we analyzed 75 fault scenarios covering a wide range of generator interturn faults. Intuitively, more scenarios provide more training data, potentially enhancing model performance in real cases. We varied the number of training and pretesting scenarios from a small set (16) to the total number of scenarios (76). Here we compare pretest results, based on a limited number of scenarios identical to the training set, with actual test results that encompass all scenarios, including an unforeseen period.

We selected 2, 4, 6, and all scenarios from each severity category according to variations in short-circuit resistance and faulty winding ratio. For instance, training number 34 corresponds to 11 (ITSCFs)×3 (phases)+1 (normal operation). Scenarios were chosen based on their proximity to category boundaries to create the set of 16, with additional scenarios randomly selected to create the sets of 52. The full set of 76 scenarios includes all simulations. For the phase identification module, which processes only medium and severe condition signals, mild severity signals were excluded, resulting in 12, 24, 36, and 45 training scenarios, respectively.

Training epochs and batch sizes were determined based on the size of the training set and performance metrics, such as training and validation evaluation metrics and loss functions. All training epochs were set to 15. Batch sizes varied according to the number of training scenarios: 256, 512, 768, and 1024 timestamps of data for the 16-, 34-, 52-, and 76-scenario training sets, respectively, for severity estimation model; 256, 512, 512, and 768 timestamps of data, respectively, for phase identification.

Both severity estimation and phase identification were treated as classification tasks. We used four popular metrics to evaluate model performance: average accuracy, average precision, average recall, and average F-measure.

Models trained on the smallest scenario set (16 scenarios) performed the worst. While most ML algorithms successfully classified scenarios during pretesting, actual test metric values dropped by up to 18.07%. Notably, in the phase identification task, actual test performance rarely surpassed pretesting performance. However, in severity estimation, pretesting metrics consistently lagged behind testing metrics when training scenarios exceeded 16, possibly due to unfavorable noise in the selected scenarios. Comparable performance in testing and pretesting with appropriate training scenarios (more than 34) suggests fewer than 76 scenarios are needed for training and testing the proposed diagnostic models. In our case, 52 scenarios sufficed.

All ML algorithms performed better in phase identification than in severity estimation. The models effectively learned the asymmetric current patterns occurring during ITSCF where the shorted current in the faulty phase exceeds the others.

Apart from accuracy, the computational cost of training each ML model and executing it at the appropriate frequency for condition monitoring is crucial for their real-world application.

In both severity estimation and phase identification tasks, the RNN algorithms, LSTM and GRU, outperform CNN in terms of accuracy metrics. However, the training time for LSTM and GRU can be more than ten times longer than that of CNN. Therefore, when implementing these algorithms in real-world scenarios, especially with high-frequency signals that generate large volumes of data in short periods, additional effort is required on the hardware or algorithmic side to balance computational cost with diagnostic accuracy.

GRU overall outperformed other algorithms in both severity estimation and phase identification task when training scenarios exceeds 16. Performance improvements are evident with increasing training scenarios, with GRU accurately estimating severity in almost all cases with 52 or more scenarios and identifying faulty phases with 34 or more scenarios.

With 16 training scenarios, the GRU model achieved a severity estimation accuracy of 89.36% and a phase identification accuracy of 98.21%, resulting in an overall system accuracy of 87.76%. This overall accuracy increased by 12.00% and 13.66% with 34 and 52 scenarios, respectively, reaching 99.95% accuracy with 52 training scenarios in this case study.

To evaluate the noise resilience of the proposed framework, three levels of White Gaussian noise were introduced to the dataset, specifically at signal-to-noise ratios (SNR) of 50 dB, 30 dB, and 10 dB. A lower SNR value corresponds to a higher noise level. Based on previous conclusions, 52 scenarios are sufficient to build our CMFD system. Therefore, in this case study, all diagnostic modules were trained using 52 scenarios, while the actual testing set comprised 76 scenarios.

The observed difference between pretesting and actual testing metric values reveals a linear relationship between noise level and the accuracy discrepancy between offline training (pretest) and online implementation (actual test). Interestingly, this correlation reverses between the severity estimation and phase identification tasks. Specifically, the diagnostic system tends to perform better in real-world conditions than during training for severity estimation but worse for phase identification. This discrepancy may be attributed to the inherent characteristics of each task. For severity estimation, while noisy signals increase the task's difficulty, a moderate level of noise can help the ML model avoid overfitting, enabling it to handle unforeseen scenarios better. Conversely, asymmetric current patterns assist the ML model in identifying faulty phases. However, increased noise levels obscure these patterns, particularly during initial fault diagnosis. Notably, the CNN algorithm excels in phase identification, maintaining accuracy even as the performance of both RNN algorithms drops below 50% in the 10 dB noise scenario. This may be due to the CNN's superior denoising capability.

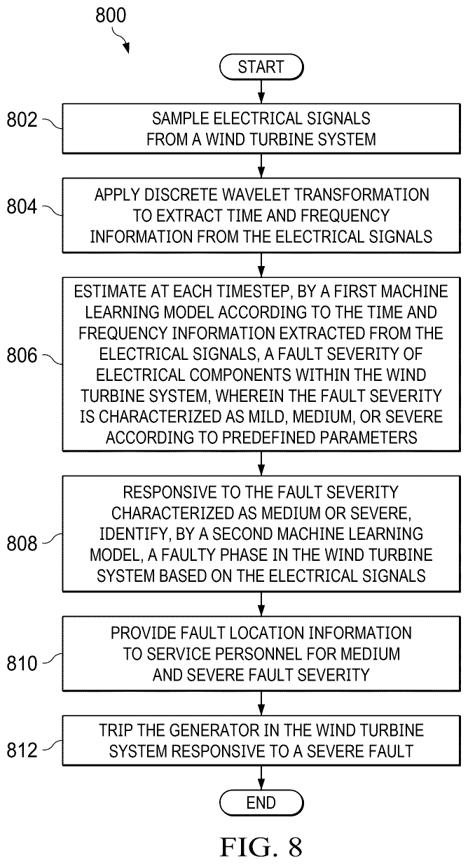

FIG. 8 depicts a flowchart illustrating a process for monitoring and maintaining wind turbine performance in accordance with an illustrative embodiment. Process 800 may be implemented with wind turbine system 100 in FIG. 1 and the bi-level condition monitoring framework shown in FIG. 5.

Process 800 begins by sampling electrical signals from a wind turbine system (step 802). The electrical signals are sampled at a rate of at least 4 kHz. The electrical signals may comprise current signals from a generator in the wind turbine system. Alternatively, the electrical signals may comprise current signals from both primary and secondary sides of a transformer in the wind turbine system.

Process 800 then applies discrete wavelet transformation to extract time and frequency information from the electrical signals (step 804). In the case of sampling generator current signals, applying the discrete wavelet transformation comprises obtaining energy coefficients of three-phase current signals. In the case of sampling transformer signals, applying the discrete wavelet transformation comprises obtaining energy coefficients of three-phase current signals for both sides of the transformer.

At each timestep a first machine learning model estimates, according to the time and frequency information extracted from the electrical signals, a fault severity of electrical components within the wind turbine system (step 806). A time series of raw current data and energy coefficients may be input into the first machine learning model. The fault severity is characterized as mild, medium, or severe according to predefined parameters. The first machine learning model may comprise an RNN. This RNN might include an LSTM or GRU architecture.

Responsive to the fault severity characterized as medium or severe, a second machine learning model identifies a faulty phase in the wind turbine system based on the electrical signals (step 808). In the case of sample from the transformer, identifying the faulty phase further comprises identifying a primary or secondary faulting winding. The second machine learning model may also comprise a recurrent neural network (RNN) with an LSTM or GRU architecture.

Fault location information is then provided to service personnel for medium and severe fault severity (step 810).

The generator in the wind turbine system may also be automatically tripped responsive to a severe fault (step 812). Process 800 then ends.

The illustrative embodiments may be carried out as a computer-implemented method. The illustrative embodiments may be implemented as a system comprising a storage device that stores program instructions one or more processors operably connected to the storage device and configured to execute the program instructions to cause the system to perform the steps of process 800. The illustrative embodiments may also be implemented as a computer program product comprising a persistent storage medium having program instructions configured to cause one or more processors to perform the steps of process 800.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The descriptions of the various embodiments of the present invention have been presented for purposes of illustration, but are not intended to be exhaustive nor is the present invention limited to the embodiments disclosed. Many modifications and variations will be apparent to those of ordinary skill in the art without departing from the scope and spirit of the described embodiment. The terminology used herein was chosen to best explain the principles of the embodiments, the practical application or technical improvement over technologies found in the marketplace, or to enable others of ordinary skill in the art to understand the embodiments disclosed here.

Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of monitoring and maintaining wind turbine performance, the method comprising:
sampling electrical signals from a wind turbine system;
applying discrete wavelet transformation to extract time and frequency information from the electrical signals;
estimating at each timestep, by a first machine learning model according to the time and frequency information extracted from the electrical signals, a fault severity of electrical components within the wind turbine system, wherein the fault severity is characterized as mild, medium, or severe according to predefined parameters;
responsive to the fault severity characterized as medium or severe, identifying, by a second machine learning model, a faulty phase in the wind turbine system based on the electrical signals; and
providing fault location information to service personnel for medium and severe fault severity.

2. The method of claim 1, further comprising tripping a generator in the wind turbine system responsive to a severe fault.

3. The method of claim 1, wherein the electrical signals are sampled at a rate of at least 4 kHz.

4. The method of claim 1, wherein the electrical signals comprise current signals from a generator in the wind turbine system.

5. The method of claim 4, wherein applying the discrete wavelet transformation further comprises obtaining energy coefficients of three-phase current signals.

6. The method of claim 1, wherein the electrical signals comprise current signals from both primary and secondary sides of a transformer in the wind turbine system.

7. The method of claim 6, wherein applying the discrete wavelet transformation further comprises obtaining energy coefficients of three-phase current signals for both sides of the transformer.

8. The method of claim 6, wherein identifying the faulty phase further comprises identifying a primary or secondary faulting winding.

9. The method of claim 1, wherein a time series of raw current data and energy coefficients are input into the first machine learning model.

10. The method of claim 1, wherein the first and second machine learning models each comprise recurrent neural networks (RNNs).

11. The method of claim 1, wherein the RNNs comprise a long short-term memory architecture.

12. The method of claim 1, wherein the RNNs comprise a gate recurrent unit architecture.

13. A system for monitoring and maintaining wind turbine performance, the system comprising:
a storage device that stores program instructions;
one or more processors operably connected to the storage device and configured to execute the program instructions to cause the system to:
sample electrical signals from a wind turbine system;
apply discrete wavelet transformation to extract time and frequency information from the electrical signals;
estimate at each timestep, by a first machine learning model according to the time and frequency information extracted from the electrical signals, a fault severity of electrical components within the wind turbine system, wherein the fault severity is characterized as mild, medium, or severe according to predefined parameters;
responsive to the fault severity characterized as medium or severe, identify, by a second machine learning model, a faulty phase in the wind turbine system based on the electrical signals; and
provide fault location information to service personnel for medium and severe fault severity.

14. The system of claim 13, wherein the processors further execute instructions to cause the system to trip a generator in the wind turbine system responsive to a severe fault.

15. The system of claim 13, wherein the electrical signals comprise current signals from a generator in the wind turbine system.

16. The system of claim 13, wherein the electrical signals comprise current signals from both primary and secondary sides of a transformer in the wind turbine system.

17. A computer program product for monitoring and maintaining wind turbine performance, the computer program product comprising:
a persistent storage medium having program instructions embodied thereon to perform the operations of:
sampling electrical signals from a wind turbine system;
applying discrete wavelet transformation to extract time and frequency information from the electrical signals;
estimating at each timestep, by a first machine learning model according to the time and frequency information extracted from the electrical signals, a fault severity of electrical components within the wind turbine system, wherein the fault severity is characterized as mild, medium, or severe according to predefined parameters;
responsive to the fault severity characterized as medium or severe, identifying, by a second machine learning model, a faulty phase in the wind turbine system based on the electrical signals; and
providing fault location information to service personnel for medium and severe fault severity.

18. The computer program product of claim 17, further comprising instructions for tripping a generator in the wind turbine system responsive to a severe fault.

19. The computer program product of claim 17, wherein the electrical signals comprise current signals from a generator in the wind turbine system.

20. The computer program product of claim 17, wherein the electrical signals comprise current signals from both primary and secondary sides of a transformer in the wind turbine system.
